(19) United States
(12) Patent Application Publication
(10) Pub. No.: US 2017/0028869 A1
(43) Pub. Date: Feb. 2, 2017

(54) THERMAL MANAGEMENT SYSTEM INCLUDING COLD PLATE AND INTEGRATED HEAT PIPE

(71) Applicant: FORD GLOBAL TECHNOLOGIES, LLC, Dearborn, MI (US)

(72) Inventors: Bhaskara BODDAKAYALA, Canton, MI (US); Suriyaprakash Ayyangar JANARTHANAM, Westland, MI (US); Neil Robert BURROWS, White Lake Twp., MI (US)

(21) Appl. No.: 14/809,732

(22) Filed: Jul. 27, 2015

(51) Int. Cl. B60L 11/18; H01M 10/625; H01M 10/6552; F28D 15/04

(52) U.S. Cl. CPC B60L 11/1874; F28D 15/04; H01M 10/625; H01M 10/6552

(57) ABSTRACT

An assembly according to an exemplary aspect of the present disclosure includes, among other things, a heat source, a cold plate positioned to conduct heat out of the heat source, and a heat pipe attached to the cold plate and configured to dissipate the heat from the cold plate.

### TECHNICAL FIELD

This disclosure relates to an assembly for an electrified vehicle. The assembly includes a cold plate and one or more heat pipes attached to the cold plate and configured to dissipate heat conducted through the cold plate from a heat source.

### BACKGROUND

The need to reduce automotive fuel consumption and emissions is well known. Therefore, vehicles are being developed that reduce or completely eliminate reliance on internal combustion engines. Electrified vehicles are one type of vehicle currently being developed for this purpose. In general, electrified vehicles differ from conventional motor vehicles because they are selectively driven by one or more battery powered electric machines. Conventional motor vehicles, by contrast, rely exclusively on the internal combustion engine to drive the vehicle.

A high voltage battery pack for powering electric machines and other electrical loads typically includes multiple battery cells. In certain conditions, such as during charging and discharging operations, heat is generated by the battery cells. This heat may need removed from the battery pack to improve battery cell capacity and life.

### SUMMARY

An assembly according to an exemplary aspect of the present disclosure includes, among other things, a heat source, a cold plate positioned to conduct heat out of the heat source, and a heat pipe attached to the cold plate and configured to dissipate the heat from the cold plate.

In a further non-limiting embodiment of the foregoing assembly, the heat source is a battery cell.

In a further non-limiting embodiment of either of the foregoing assemblies, the cold plate and the heat pipe are made of a similar material.

In a further non-limiting embodiment of any of the foregoing assemblies, the similar material is aluminum.

In a further non-limiting embodiment of any of the foregoing assemblies, a second heat pipe is attached to the cold plate at a location adjacent to the heat pipe, the second heat pipe configured to dissipate the heat.

In a further non-limiting embodiment of any of the foregoing assemblies, a thermal interface material is disposed between the heat source and the cold plate.

In a further non-limiting embodiment of any of the foregoing assemblies, an enclosure houses the heat source and the cold plate, and the heat pipe extends through a wall of the enclosure.

In a further non-limiting embodiment of any of the foregoing assemblies, the heat pipe extends into a channel of a coolant manifold.

In a further non-limiting embodiment of any of the foregoing assemblies, the heat pipe includes a condenser portion extending into the channel.

In a further non-limiting embodiment of any of the foregoing assemblies, the heat pipe includes a wick and a vapor cavity disposed inside a casing.

In a further non-limiting embodiment of any of the foregoing assemblies, a working fluid is configured to flow within the wick between an evaporator portion and a condenser portion of the heat pipe.

In a further non-limiting embodiment of any of the foregoing assemblies, the working fluid includes liquid ammonia.

A battery pack according to another exemplary aspect of the present disclosure includes, among other things, a cold plate, a battery array positioned atop the cold plate, an enclosure generally surrounding the cold plate and the battery array, a coolant manifold external to the enclosure and a heat pipe attached to the cold plate and extending into the coolant manifold.

In a further non-limiting embodiment of the foregoing battery pack, a thermal interface material is disposed between the battery array and the cold plate.

In a further non-limiting embodiment of either of the foregoing battery packs, the battery array includes a plurality of battery cells and a plurality of spacers disposed between the plurality of battery cells.

In a further non-limiting embodiment of either of the foregoing battery packs, a thermally conductive film is wrapped around each of the plurality of battery cells.

A method according to another exemplary aspect of the present disclosure includes, among other things, conducting heat into a cold plate of an assembly and dissipating the heat from the cold plate through a heat pipe that is attached to the cold plate.

In a further non-limiting embodiment of the foregoing method, the heat is generated by at least one battery cell.

In a further non-limiting embodiment of either of the foregoing methods, the dissipating step includes communicating the heat to a location external to the assembly and releasing at least a portion of the heat to a coolant communicated across the heat pipe.

In a further non-limiting embodiment of any of the foregoing methods, the dissipating step includes evaporating and condensing a working fluid inside the heat pipe.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 is a cross-sectional view of a battery assembly of an electrified vehicle.

FIG. 3 is a top, cross-sectional view of a battery assembly.

FIG. 4 illustrates an exemplary heat pipe.

### DETAILED DESCRIPTION

This disclosure details an assembly for an electrified vehicle. The assembly includes a cold plate and one or more heat pipes attached to the cold plate. In some embodiments, battery cells or other heat sources may be positioned atop the cold plate. Heat released by the heat source is conducted through the cold plate and is then dissipated by the heat pipe. In some embodiments, the heat pipe extends outside of an enclosure of the assembly and exchanges heat with a coolant within a coolant manifold. In other embodiments, the heat pipe and the cold plate are made from similar materials, such as aluminum, for example. These and other features are discussed in greater detail in the following paragraphs of this detailed description.

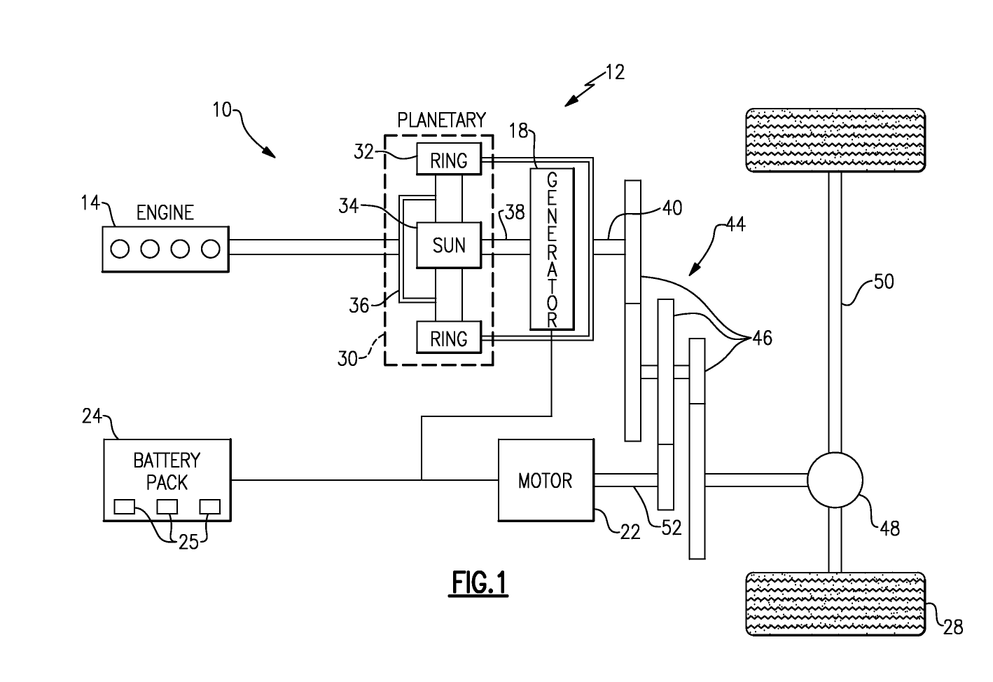

FIG. 1 schematically illustrates a powertrain 10 for an electrified vehicle 12. Although depicted as a hybrid electric vehicle (HEV), it should be understood that the concepts described herein are not limited to HEV's and could extend to other electrified vehicles, including, but not limited to, plug-in hybrid electric vehicles (PHEV's), battery electric vehicles (BEV's) and fuel cell vehicles.

In one non-limiting embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electrified vehicle 12. Although a power-split configuration is shown, this disclosure extends to any hybrid or electric vehicle including full hybrids, parallel hybrids, series hybrids, mild hybrids or micro hybrids.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22, the generator 18 and/or other electrical loads of the electrified vehicle 12. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

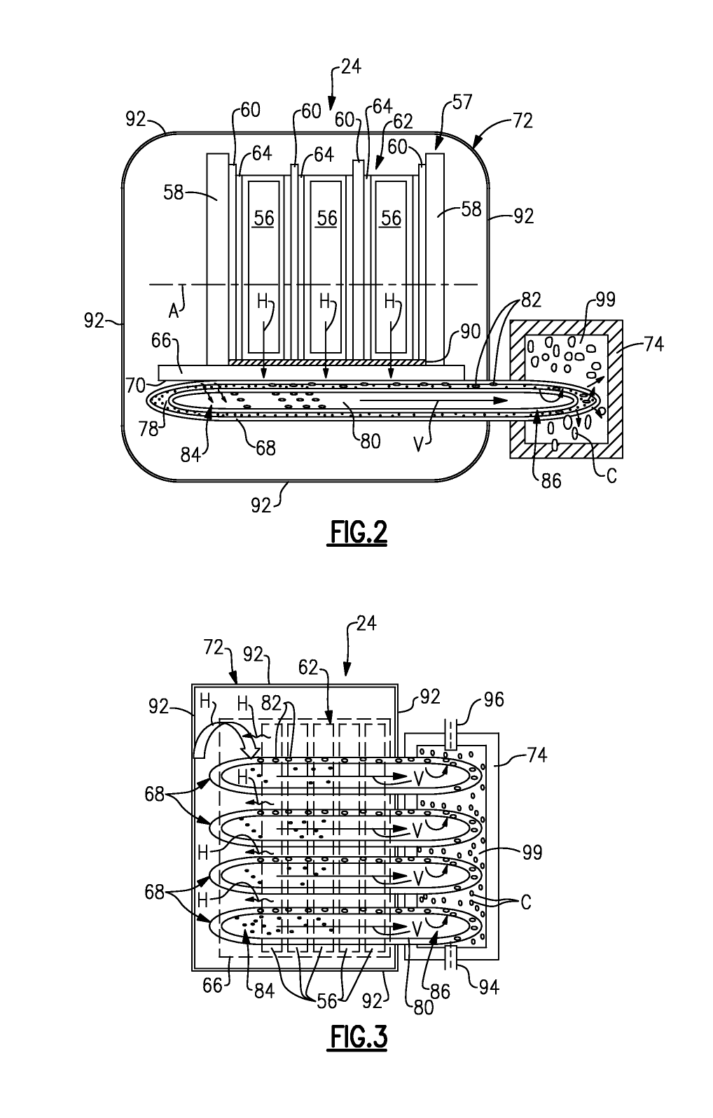

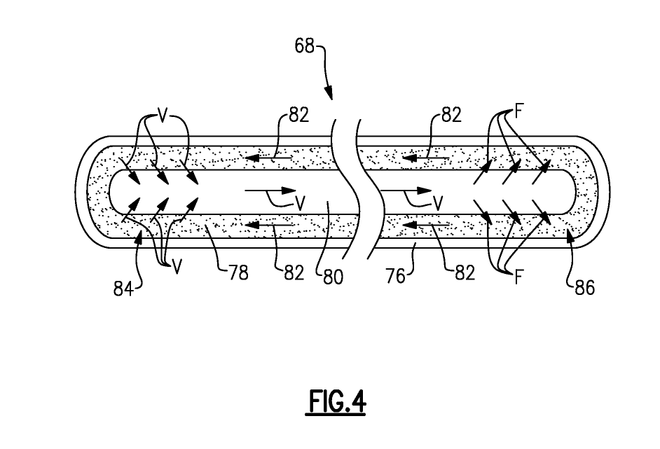

FIGS. 2 and 3 illustrate a battery pack 24 that can be employed within an electrified vehicle. For example, the battery pack 24 could be part of the electrified vehicle 12 of FIG. 1. The battery pack 24 includes a plurality of battery cells 56 for supplying electrical power to various electrical loads of the electrified vehicle 12. Although a specific number of battery cells 56 are depicted in FIGS. 2-3, the battery pack 24 could employ a fewer or a greater number of battery cells within the scope of this disclosure. In other words, this disclosure is not limited to the specific configurations shown in FIGS. 2 and 3.

The battery cells 56 may be stacked side-by-side along a longitudinal axis A to construct a grouping of battery cells 56, sometimes referred to as a “cell stack.” In one non-limiting embodiment, the battery cells 56 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

In one non-limiting embodiment, the battery cells 56 are sandwiched between a support structure 57, which may include end plates 58 and, optionally, spacers 60. For example, a plurality of battery cells 56 and spacers 60 may be arranged side-by-side in an alternating fashion between the end plates 58. The spacers 60, which could also be referred to as separators or dividers, are thermally insulated and may be positioned at opposing ends of the stack of battery cells 56 and between adjacent battery cells 56. The opposing end plates 58 are positioned outboard of the spacers 60. The spacers 60 may include thermally resistant and electrically isolating plastics and/or foams that exhibit relatively high thermal insulating capabilities. The support structure 57 axially constrains the stacked battery cells 56. The battery cells 56 and support structure 57 are together referred to as a battery array 62. Although only a single battery array 62 is shown in FIGS. 2-3, the battery pack 24 could include multiple battery arrays 62.

In another non-limiting embodiment, a thermally conductive film 64 may be wrapped around each battery cell 56. The thermally conductive films 64 facilitate thermal conduction between adjacent battery cells 56 and also electrically isolate adjacent battery cells 56 from one another. The thermally conductive films 64 may additionally establish a dielectric barrier between adjacent battery cells 56 of each battery array 62.

The battery pack 24 may be equipped with various features for thermally managing the battery cells 56. For example, heat H may be generated and released by the battery cells 56 during charging operations, discharging operations, extreme ambient conditions, or other conditions. It is often desirable to remove the heat H from the battery pack 24 to improve capacity and life of the battery cells 56. Although this embodiment is directed to thermally managing the battery pack 24, the features of this disclosure may be utilized to thermally manage any high voltage electronic module, including but not limited to, battery packs, ISC modules, chargers, DCDC modules, or any other module that generates heat during operation. In one non-limiting embodiment, the battery pack 24 includes a cold plate 66, which may alternatively be referred to as a heat exchanger plate. The battery array 62 is positioned atop the cold plate 66. The heat H from the battery cells 56 may be conducted into the cold plate 66.

In one non-limiting embodiment, a thermal interface material 90 may be positioned between the cold plate 66 and at least a portion of the battery array 62. The thermal interface material 90 provides a thermally conductive interface between the heat source (i.e., the battery cells 56) and the heat sink (i.e., the cold plate 66) and also fills variations between the heat source and the heat sink.

One or more heat pipes 68 may be attached to the cold plate 66. This disclosure is not limited to a specific number of heat pipes 68 and the actual number of heat pipes 68 used for any given cooling application will vary depending upon the cooling requirements of the battery pack 24, among other factors. In addition, the heat pipes 68 shown in FIGS. 2 and 3 are not drawn to scale. Instead, these features have been enlarged to better illustrate their various features and functions.

Each heat pipe 68 may be attached to a bottom surface 70 of the cold plate 66 such that it is substantially integrated with the cold plate 66. Other mounting locations are also contemplated within the scope of this disclosure. The heat pipes 68 may be brazed or otherwise mounted to the cold plate 66. The heat pipes 68 and the cold plate 66 may also be made of similar materials. For example, in one non-limiting embodiment, the heat pipes 68 and the cold plate 66 are made from aluminum. Other materials may also be suitable.

An enclosure 72 generally surrounds each battery array 62 and the cold plate 66 of the battery pack 24. The enclosure 72 may be made up of one or more walls 92 that house the components of the battery pack 24.

The heat pipes 68 may protrude through at least one of the walls 92 of the enclosure 72 and extend into a coolant manifold 74. The coolant manifold 74 may communicate a coolant C for removing heat from the heat pipes 68. The coolant C may be a conventional type of coolant mixture such as water mixed with ethylene glycol. However, other coolants are also contemplated and could alternatively be communicated within the coolant manifold 74.

The coolant manifold 74 includes an inlet port 94 and an outlet port 96 that are both located external to the enclosure 72 (best shown in FIG. 3). In this way, the potential for fluid leaks inside the enclosure 72 of the battery pack 24 is substantially eliminated. Although not shown, the coolant C exiting the outlet port 96 may be delivered to a radiator or some other heat exchanging device for cooling before being returned to the inlet port 94 in a closed loop.

FIG. 4 illustrates an exemplary heat pipe 68 for use within the battery pack shown in FIGS. 2 and 3. The heat pipe 68 includes a casing 76, an evaporator potion 84, a condenser portion 86, a wick 78 and a vapor cavity 80. In one non-limiting embodiment, the casing 76 of the heat pipe 68 is made of aluminum. A working fluid 82, such as liquid ammonia, is disposed inside the casing 76 and may be communicated through the wick 78, which is porous. The working fluid 82 may evaporate into a vapor V at the evaporator portion 84 of the heat pipe 68. As evaporation occurs, the vapor V absorbs thermal energy. The vapor V may then migrate along the vapor cavity 80 toward the condenser portion 86 of the heat pipe 68. In the condenser portion 86, the vapor V condenses back to fluid F and is absorbed by the wick 78, thereby releasing thermal energy. The working fluid 82 may then flow back toward the evaporator portion 84.

Thermal management of the battery pack 24 is schematically shown in FIGS. 2, 3 and 4 and generally occurs in the following manner. Heat H is generated and released by the battery cells 56 or some other heat source and is conducted into the cold plate 66. The heat H conducted into the cold plate 66 is then dissipated from the battery pack 24 by the integrated heat pipes 68. For example, as the cold plate 66 absorbs the heat H, the working fluid 82 in the evaporator portion 84 vaporizes, thereby creating a pressure gradient within the heat pipe 68. This pressure gradient forces the vapor V to flow along the vapor cavity 80 to the cooler, condenser portion 86 that is located external to the enclosure 72 and extends into the coolant manifold 74. The vapor V condenses in the condenser portion 86, thereby releasing latent heat LH to the coolant C that is communicated through a channel 99 of the coolant manifold 74. The working fluid 82 is then returned to the evaporator portion 84 by capillary forces developed in the wick 78. Removing the heat H from the battery pack 24 in this manner maintains the battery cells 56 of the battery pack 24 within a desired operating temperature range.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An assembly, comprising:
a heat source;
a cold plate positioned to conduct heat out of said heat source; and
a heat pipe attached to said cold plate and configured to dissipate said heat from said cold plate.

2. The assembly as recited in claim 1, wherein said heat source is a battery cell.

3. The assembly as recited in claim 1, wherein said cold plate and said heat pipe are made of a similar material.

4. The assembly as recited in claim 3, wherein said similar material is aluminum.

5. The assembly as recited in claim 1, comprising a second heat pipe attached to said cold plate at a location adjacent to said heat pipe, said second heat pipe configured to dissipate said heat.

6. The assembly as recited in claim 1, comprising a thermal interface material disposed between said heat source and said cold plate.

7. The assembly as recited in claim 1, comprising an enclosure that houses said heat source and said cold plate, and said heat pipe extends through a wall of said enclosure.

8. The assembly as recited in claim 7, wherein said heat pipe extends into a channel of a coolant manifold.

9. The assembly as recited in claim 8, wherein said heat pipe includes a condenser portion extending into said channel.

10. The assembly as recited in claim 1, wherein said heat pipe includes a wick and a vapor cavity disposed inside a casing.

11. The assembly as recited in claim 10, comprising a working fluid configured to flow within said wick between an evaporator portion and a condenser portion of said heat pipe.

12. The assembly as recited in claim 11, wherein said working fluid includes liquid ammonia.

13. A battery pack, comprising:
a cold plate;
a battery array positioned atop said cold plate;
an enclosure generally surrounding said cold plate and said battery array;
a coolant manifold external to said enclosure; and
a heat pipe attached to said cold plate and extends into said coolant manifold.

14. The battery pack as recited in claim 13, comprising a thermal interface material disposed between said battery array and said cold plate.

15. The battery pack as recited in claim 13, wherein said battery array includes a plurality of battery cells and a plurality of spacers disposed between said plurality of battery cells.

16. The battery pack as recited in claim 15, comprising a thermally conductive film wrapped around each of said plurality of battery cells.

17. A method, comprising:
conducting heat into a cold plate of an assembly; and
dissipating the heat from the cold plate through a heat pipe that is attached to the cold plate.

18. The method as recited in claim 17, wherein the heat is generated by at least one battery cell.

19. The method as recited in claim 17, wherein the dissipating step includes:
communicating the heat to a location external to the assembly; and
releasing at least a portion of the heat to a coolant communicated across the heat pipe.

20. The method as recited in claim 17, wherein the dissipating step includes:
evaporating and condensing a working fluid inside the heat pipe.
